(19) United States
(12) Patent Application Publication
(10) Pub. No.: US 2026/0271957 A1
(43) Pub. Date: Sep. 17, 2026

(54) CHOCOLATE MOUSSE COMPRISING EGG AND FREE FROM TEXTURIZING INGREDIENT AND PROCESS FOR PREPARING SAME

(71) Applicant: SOCIÉTÉ DES PRODUITS NESTLÉ S.A., Vevey (CH)

(72) Inventors: Jean-François CHEVALIER, Courtonne-la-Meurdrac (FR); Aurore Céline CHETIOUI, Evreux (FR); Alain TREMELO, Douvres-la-Délivrande (FR); Jennifer LEMARINEL, Mézidon Vallée d'Auge (FR)

(21) Appl. No.: 19/472,327

(22) PCT Filed: Apr. 4, 2024
(86) PCT No.: PCT/EP2024/059143

§ 371 Date: Oct. 3, 2025

(30) Foreign Application Priority Data
Apr. 6, 2023 (EP) 23166959.9

(51) Int. Cl. A23G 1/52; A23G 1/00; A23G 1/40; A23G 1/46

(52) U.S. Cl. CPC A23G 1/52; A23G 1/003; A23G 1/40; A23G 1/46

(57) ABSTRACT

The present invention relates to the field of chocolate mousse comprising egg, especially chocolate mousse comprising egg and free from texturizing ingredient. The invention also relates to a process for the preparation of a chocolate mousse comprising egg and free from texturizing ingredient. The invention is further directed to a chocolate mousse comprising egg and free from texturizing ingredient that may be obtained by carrying out the process according to the invention.

### FIELD OF THE INVENTION

The present invention relates to the field of chocolate mousse comprising egg, especially chocolate mousse comprising egg and free from texturizing ingredient. The invention also relates to a process for the preparation of a chocolate mousse comprising egg and free from texturizing ingredient. The invention is further directed to a chocolate mousse comprising egg and free from texturizing ingredient that may be obtained by carrying out the process according to the invention.

### BACKGROUND

Traditional home-made chocolate mousse prepared at home is made by melting chocolate and by folding it into whipped egg white. In some recipes, the chocolate can be melted with butter, cream, egg yolk and mixture thereof to produce a chocolate ganache prior to folding it into whipped egg white. Then, the mousse is cooled in the fridge for at least 1 hour. Home-made chocolate mousse has a characteristic thermal and visco-elastic behaviour such as a low aerated structure associated with a rapid melting in the mouth. Home-made chocolate mousse are also quite firm.

Home-made chocolate mousse can be stored in the fridge only for a few days at most and can be consumed a few days after its production. However, after few days, the home-made chocolate mousse starts to melt down, i.e the bubbles of air go off the mousse, and a viscous liquid type chocolate mousse starts to appear in the bottom of the container losing all the organoleptic properties of the home-made chocolate mousse.

Chocolate mousses are indeed meta-stable systems with a relatively low shelf-life. Gas bubbles are dispersed in a liquid/semi-liquid phase and are stabilised by a thin film of proteins and fat. As soon as the chocolate mousse is formed, destabilisation begins due to drainage, coalescence and disproportionation. Drainage is the phenomenon whereby liquid in the thin film drains by gravity. Coalescence is the phenomenon whereby neighbouring gas bubbles merge together, for instance due to disproportionation. Disproportionation occurs due to gas pressure differences between bubbles of unequal sizes. These destabilization phenomena result in the decrease of the overrun and in the alteration of the pleasant aerated texture of the chocolate mousses over the shelf-life.

There is thus a need to provide a home-made type chocolate mousse which retains its organoleptic properties, firmness and appearance over the shelf-life, especially its organoleptic properties and appearance for at least 30 days, preferably for at least 45 days, and which has a rapid melting in the mouth and a low aerated structure.

EP 2 124 619 describes a shelf-stable chocolate mousse comprising an aerated oil-in-water emulsion and stored at room temperature that has a mouthfeel similar to traditional chocolate mousse.

On the chilled dairy market, there are two types of chilled chocolate mousses, the one comprising egg and which are marketed as home-made type chocolate mousse and the one free from egg.

Chilled chocolate mousses free from egg usually have an excellent appearance, texture and retain their organoleptic properties over shelf-life. However, the replacement of egg, which gives the aerated texture and the firmness to the chocolate mousse, is done by addition of one or more texturizing agents usually combined with one or more emulsifier agents. The addition of the texturizing ingredient allows increasing the firmness, the texture and the stability of the chocolate mousse over the shelf-life. The texturizing ingredient is selected from the group consisting of gelatin, xanthan gum, carrageenan, agar, alginate, cellulose, gellan gum, locust bean gum, guar gum, tara gum, acacia gum, starch, flour, fiber, pectin and combinations thereof.

Nowadays, consumers wish to consume clean-label food products, i.e with less ingredients such as texturizing ingredient and emulsifier, and which have similar organoleptic properties than home-made food type product. This trend also applies to the market of home-made type chocolate mousse.

On the other side, the chocolate mousses which are marketed as home-made type chocolate mousses comprise egg. As above-mentioned, the addition of egg, i.e. both egg white and egg yolk, in a chocolate mousse recipe allows improving the firmness and the foamability of said mousses with an overrun in the same range than the overrun of the traditional home-made chocolate mousse while keeping a nice mouthfeel. More particularly, the addition of egg yolk in the chocolate mousse allows to improve the firmness of said mousse due to the high protein content oft he egg yolk.

However, the addition of egg yolk in a home-made type chocolate mousse recipe can be perceived by the consumer as an unpleasant taste because the taste of egg yolk is too pronounced and masks the taste of chocolate.

Therefore, to reduce the quantity of egg yolk incorporated in the recipe of home-made type chocolate mousses, some food companies increase the fat content by adding cream and/or butter in the recipe. The partial or total replacement of egg yolk by fat leads to a product with a high fat content.

Another option to mask the unpleasant taste of egg yolk in the home-made type chocolate mousse is to add sugars in the recipe.

Such home-made chocolate mousses are not praised by the consumers due to the high fat content and/or the high sugar content in the recipe, both leading to nutritional concerns.

There is further a need to provide a home-made type chocolate mousse which retains its organoleptic properties, firmness and appearance over the shelf-life, which has a rapid melting in the mouth and a low aerated structure, and which has an acceptable nutritional value for the consumer and a pleasant taste. Especially, there is a need to provide a home-made type chocolate mousse which retains its organoleptic properties, firmness and appearance over the shelf-life, which has a rapid melting in the mouth and a low aerated structure and which has an acceptable content of fat, a low content of added sugars, i.e, sugar added in addition to the one already present in the chocolate, and a pleasant taste, i.e free from egg yolk.

Alternatively, some food companies find a compromise by replacing part of the content of egg yolk and/or part of the content of fat by some texturizing ingredients such as pectin and fiber.

For the reasons above-mentioned, such type of home-made type mousse are not clean-label food products and therefore are not praised by the consumer.

There is further a need to provide a home-made type chocolate mousse with the above benefits and which is a clean-label home-made type chocolate mousse. Especially, there is a need to provide a home-made type chocolate mousse with the above benefits and which is free from texturizing ingredient and has no other emulsifier than the one already present in the chocolate.

### OBJECT OF THE INVENTION

The objective of the present invention is it to improve the state of the art and in particular to provide a home-made type chocolate mousse that is a clean-label chocolate mousse, i.e free from texturizing ingredients, that provides good nutritional and taste profiles and that retains its organoleptic properties, firmness and appearance over the shelf-life.

### SUMMARY OF THE INVENTION

The present invention provides the improvement by the subject matter of the independent claims. The dependent claims further develop the idea of the present invention.

In a first aspect, the invention relates to a chocolate mousse composition comprising:
from 20 to 60% of at least one dairy ingredient,
from 10 to 40% of at least one chocolate ingredient, preferably from 20 to 40%,
from 10 to 40% of at least one egg ingredient, preferably from 10 to 30%,
   wherein the composition is free from texturizing agent,
   the percentages being defined by weight of ingredient as compared to the total weight of the composition.

In a second aspect, the invention relates to a process for the preparation of a chocolate mousse composition according to the invention comprising the steps of:
a) preparing a chocolate ganache composition comprising at least one dairy ingredient and at least one chocolate ingredient,
b) aerating the chocolate ganache composition obtained at step a) in a first aeration device,
c) aerating the at least one egg ingredient in a second aeration device, said second aeration device is different from the first aeration device,
d) mixing the aerated chocolate ganache composition obtained at step b) with the at least aerated egg ingredient obtained at step c), preferably with egg white, in the second aeration device.

The present inventors have shown that the composition of the present invention achieves the objective of the present invention and in particular, that the chocolate mousse composition according to the invention achieves the objective of the present invention. The chocolate mousse composition of the present invention was found to have a rapid melting in mouth combined with a low aerated structure while retaining its organoleptic properties, firmness and appearance over the shelf-life. In addition, the chocolate mousse according to the invention provides good nutritional and taste and melting profiles without using any texturizing ingredients nor any other emulsifier than the one present in the chocolate and also without using egg yolk.

### BRIEF DESCRIPTION OF THE DRAWINGS

FIG. 1 shows the firmness of the chocolate mousse composition according to the invention and a commercially available home-made type chocolate mousse composition comprising egg yolk after 14 days (D+14) and after 28 days (D+28) of storage under the same chilled conditions.

FIG. 2 shows the storage modulus (G′) and the loss modulus (G″) across temperature of the chocolate mousse composition according to the invention and a commercially available home-made type chocolate mousse composition comprising egg yolk after 14 days (D+14) of storage under chilled conditions. The combination of the storage modulus (G′) and the loss modulus (G″) across temperature translates the behaviour of said compositions with the temperature inside the mouth.

FIG. 3 shows the storage modulus (G′) and the loss modulus (G″) across shear stress of the chocolate mousse compositions according to the invention after 7 days (D+7) of storage under chilled conditions. The intersecting point between the curves G′ and G″ is the transition point of the chocolate mousse composition from an aerated phase towards to a liquid phase.

The combination of the storage modulus (G′) and the loss modulus (G″) across shear stress translates the behaviour of said compositions with the action of the tong in the mouth.

### DETAILED DESCRIPTION OF THE INVENTION

As used in this specification, the words “comprises”, “comprising”, and similar words, are not to be interpreted in an exclusive or exhaustive sense. In other words, they are intended to mean “including, but not limited to”.

The expression “comprised between X and Y” includes boundaries, unless explicitly stated otherwise. This expression means that the target range includes the X and Y values, and all values from X to Y.

The present invention relates to a chocolate mousse composition comprising:
from 20 to 60% of at least one dairy ingredient,
from 10 to 40% of at least one chocolate ingredient,
from 10 to 40% of at least one egg ingredient,
   wherein the composition is free from texturizing agent,
   the percentages being defined by weight of ingredient as compared to the total weight of the composition.

In one preferred embodiment, the composition comprises:
from 30 to 50% of at least one dairy ingredient,
from 20 to 40% of at least one chocolate ingredient,
from 10 to 30% of at least one egg ingredient,
   the percentages being defined by weight of ingredient as compared to the total weight of the composition.

The inventors have surprisingly found that the chocolate mousse composition according to the invention has a rapid melting in the mouth combined with a low aerated structure and retains its firmness over shelf-life without the use of any texturizing ingredient.

The term “home-made type chocolate mousse” means a chocolate mousse comprising chocolate ingredient and eggs ingredients, preferably egg white, and which has similar characteristics when compared to traditional home-made chocolate mousse such as a rapid melting in the mouth, a firmness over shelf-life and a low aerated structure, preferably an overrun ranging from 40% to 100%, more preferably from 50% to 100%.

In one embodiment, the composition has an overrun of at most 100%, preferably comprised between 40% and 100%, more preferably comprised between 50% and 100%. The term “overrun” indicates the quantity of gas incorporated into a product (e.g. food product). The overrun (OR) is calculated according to the following equation:

$$O R = ( Po / Pf ) \times 100 - 100$$

where Po is the weight of a predetermined volume Vc of a product before incorporation of gas (i.e. before aeration), and Pf is the weight of the same volume Vc of the product after incorporation of a gas (i.e. after aeration), for instance by whipping. The weights Pf and Po are measured at the same pressure and temperature.

In one embodiment, the composition has a total fat content of at most 30% by weight of fat as compared to the total weight of the composition, preferably from 10% to 30%, more preferably from 20% to 30%.

The term “total fat content” refers to the content of fat of the composition and resulting from the addition of the fat content present in each ingredient of the composition.

In one embodiment, the composition has a total protein content of less than 10% by weight as compared to the total weight of the composition, preferably from 2.0% to 10%, more preferably from 2.0% to 8.0%, advantageously from 3.0% to 8.0%.

The term “total protein content” refers to the content of protein of the composition and resulting from the addition of the protein content present in each ingredient of the composition.

In one embodiment, the composition has a total sugar content of less than 25% by weight as compared to the total weight of the composition, preferably from 5% to 25%, more preferably from 8% to 20%, advantageously from 10% to 20%.

The term “total sugar content” refers to the content of sugar of the composition and resulting from the addition of added sugar and any sugars present in each ingredient of the composition.

In one embodiment, the composition is a chilled composition.

By “chilled”, it is understood a chocolate mousse composition which is stored under chilled conditions. The term “chilled conditions” refers to temperatures ranging from 2° C. to 15° C., preferably from 4° C. to 8° C. Especially, a chilled chocolate mousse composition has a shelf-life of at least 30 days, preferably of at least 45 days when stored under chilled conditions. These storage temperatures relate to the storage of the product before being commercially obtained by an end consumer. Generally, the end consumer is advised to store the product under the same chilled conditions until consumption, for example in a refrigerator.

In one embodiment, the chilled composition is not frozen. For example, it is not an ice cream. Non-frozen chocolate mousse composition (e.g. chilled chocolate mousse composition) with overruns similar to traditional chocolate mousse, in particular without texturizing ingredient, are difficult to achieve and stabilize as they are meta-stable systems compared to frozen aerated dairy products which are more stable due to the solid/frozen state.

In one embodiment, the chocolate mousse composition is free from any further added emulsifying component other than the one present in the chocolate ingredient.

Preferably, the chocolate mousse composition is free from any further added emulsifying component selected from the group consisting of soy lecithin, sunflower lecithin, and mixture thereof other than the one present in the chocolate ingredient.

It has been surprisingly found that without addition of texturizing ingredient, nor further added emulsifier than the one already present in the chocolate ingredient, the chocolate mousse according to the invention retains its appearance over shelf-life while having a rapid melting in mouth. The stabilization of the air bubbles trapped within the chocolate mousse is due to a specific selection of dairy ingredients further combined with aerated egg white in specific amounts.

In one embodiment, the composition has a firmness of at most 300 mN, preferably comprised between 40 and 300 mN, more preferably comprised between 40 and 250 mN.

The gel firmness is measured by a texture analyser at a temperature of 8° C. The instrument used is Stable Micro Systems TA-XTplus.

The term “gel firmness” also named “firmness” corresponds to a maximum penetration force in N.

For example, a traditional home-made mousse has a firmness comprised between 50 mN and 250 mN.

Moreover, it has been surprisingly found that the firmness of the chocolate mousse composition according to the invention free from texturizing ingredient and free from egg yolk is similar to other commercially available home-made type chocolate mousse comprising at least egg yolk, even similar over shelf-life.

The composition according to the invention comprises from 20 to 60% of at least one dairy ingredient, preferably from 30 to 50% by weight of ingredient as compared to the total weight of the composition.

In one embodiment, the composition comprises from 20 to 60% of at least two dairy ingredients, preferably from 30 to 50% by weight of ingredient as compared to the total weight of the composition.

Preferably, the composition comprises from 20 to 60% of two dairy ingredients, preferably from 30 to 50% by weight of ingredient as compared to the total weight of the composition.

By “dairy ingredient”, it is understood ingredients which are originated from non-human mammal milk, such as cow milk, goat milk, ewe milk, camel milk, donkey milk. For avoidance of doubt, the term “dairy ingredient” includes milk, i.e. non-human mammal milk, preferably cow milk. Preferably, the dairy ingredients are originated from cow milk.

In one embodiment, the dairy ingredient is selected from the group consisting of liquid milk, milk fat, milk powder, milk proteins, dairy curd, cream, buttermilk, butter, condensed milk and combinations thereof.

Preferably, the dairy ingredient is selected from the group consisting of liquid milk, milk fat, cream, butter and combinations thereof.

Advantageously, the dairy ingredient is a combination of cream and butter.

The liquid milk is selected from the group consisting of whole milk, semi-skimmed milk, a skimmed milk and combinations thereof.

The dairy curd corresponds to the dairy coagulum, optionally strained, which is obtained by treating dairy ingredients such as milk with rennet and/or lactic acid strains. Examples of milk proteins include casein, caseinate, casein hydrolysate, whey, whey hydrolysate, whey concentrate, whey isolate, milk protein concentrate, milk protein isolate, and combinations thereof.

Furthermore, the milk proteins may include, for example, sweet whey, acid whey, α-lactalbumin, β-lactoglobulin, bovine serum albumin, acid casein, caseinates, α-casein, β-casein, and/or γ-casein. The dairy component may also further comprise water in addition to the dairy ingredient(s).

In one embodiment, the dairy ingredient has a total fat content of at least 15% by weight as compared to the total weight of the dairy ingredient, preferably from 15% to 50%, more preferably from 15% to 50%, advantageously from 25% to 50%.

The composition according to the invention comprises from 10 to 40% of at least one chocolate ingredient, preferably from 20 to 40%, by weight of ingredient as compared to the total weight of the composition.

In one embodiment, the composition comprises from 10 to 40% of at least two chocolate ingredients, preferably from 20 to 40%, by weight of ingredient as compared to the total weight of the composition.

In one embodiment, the chocolate ingredient may be in a liquid form, a solid form, a powder form or a combination thereof.

The term “chocolate ingredient” refers to a food product comprising at least cocoa mass and sugar. Cocoa mass is also known as cocoa liquor. Especially, cocoa mass or cocoa liquor refers to the paste obtained by grinding roasted, cleaned and deshelled cocoa beans.

The chocolate ingredient may further comprise one or more ingredients selected among the list consisting of added cocoa butter, cocoa powder, natural flavours, vegetable oils, natural sweeteners and combinations thereof.

In one embodiment, the chocolate ingredient is selected from the group consisting of chocolate, cocoa and combinations thereof.

The chocolate is selected from the group consisting of dark chocolate, milk chocolate, ruby chocolate, white chocolate, dulcey chocolate and combinations thereof, preferably dark chocolate, milk chocolate and combinations thereof.

In another embodiment, the chocolate ingredient has a total fat content of at least 15% by weight as compared to the total weight of the chocolate ingredient, preferably from 15% to 50%, more preferably from 15% to 40%, advantageously from 20% to 40%.

The composition according to the invention comprises from 10 to 40% of at least one egg ingredient, preferably from 10 to 30% by weight of ingredient as compared to the total weight of the composition.

The term “egg ingredient” is intended to mean both whole eggs and egg constituents such as egg white or egg yolk.

In a preferred embodiment, the egg ingredient is egg white, advantageously aerated egg white.

In another preferred embodiment, the composition according to the invention is free from egg yolk.

It has been surprisingly found that the combination of the dairy ingredient, the egg white and the chocolate ingredient in the specific amounts as above-detailed leads to a chocolate mousse composition that retains its firmness over shelf-life without the use of egg yolk nor texturizing ingredient. In addition, the composition according to the invention has a rapid melting in the mouth which is similar to commercially available home-made type chocolate mousse.

In one embodiment, the composition comprises optionally added sugars, preferably from 0.5 to 3% of added sugars by weight as compared to the total weight of the composition, more preferably from 1% to 2%.

The term “added sugars” means the sugar added in the composition on top of the sugar already present in the other ingredients such as for example the chocolate ingredient.

Many sugars can be used for this purpose. Preferably the sugar is from sugar cane or beet. For example, the sugar used in the framework of the present invention may be beet sugar.

In one preferred embodiment, the composition is free from added sugars.

In one embodiment, the chocolate mousse composition consists essentially of:
from 20 to 60% of at least one dairy ingredient, preferably from 30 to 50%,
from 10 to 40% of at least one chocolate ingredient, preferably from 20 to 40%,
from 10 to 40% of at least one egg ingredient, preferably from 10 to 30%,
   wherein the composition is free from texturizing agent,
   the percentages being defined by weight of ingredient as compared to the total weight of the composition.

The dairy ingredient, the texturizing ingredient, the chocolate ingredient and the egg ingredient are above defined

The invention also relates to a process for the preparation of a chocolate mousse composition according to the invention comprising the steps of:
a) preparing a chocolate ganache composition comprising at least one dairy ingredient and at least one chocolate ingredient,
b) aerating the chocolate ganache composition obtained at step a) in a first aeration device,
c) aerating the at least one egg ingredient in an aeration device, said aeration device is the first aeration device used in step b) or is a second aeration device different from the first aeration device used in step b),
d) mixing the aerated chocolate ganache composition obtained at step b) with the at least aerated egg ingredient obtained at step c), preferably with egg white, in the second aeration device.

In one embodiment, the step c) is carried out at the same time than the step b) or before the step b) or after the step b). Preferably, the step c) is carried out at the same time than the step b) or after the step b).

In one embodiment, the chocolate ganache composition has a viscosity of at most 2000 cP, preferably comprised between 100 and 2000 cP, more preferably comprised between 300 and 1000 cP.

The viscosity of the chocolate ganache composition according to the invention is measured by a HAAKE™ VT-550 Viscometer equipped with a T/SV-DIN rotor.

In a preferred embodiment, the first and the second aeration devices are in series.

According to the invention, the aeration steps b) and c) are performed by means of an aeration device which is an apparatus as described in WO2013/068426 A1, WO2017/067965 A1 or WO2018/197493 A1. Features of apparatuses described in WO2013/068426 A1, WO2017/067965 A1 or WO2018/197493 A1 are incorporated into the present application.

In one embodiment, the aeration device comprises a housing extending in a longitudinal direction, the housing comprising an inlet and an outlet,
within the housing, at least a first set of a rotor and a stator and a second set of a rotor and a stator, wherein each set of a rotor and a stator has complementary toothed rims oppositely orientated in the longitudinal direction,
the aeration device comprising a drive shaft, the rotors of each set of a rotor and a stator being coupled to said drive shaft;
the aeration device further comprising a gas injector for injecting a gas, upstream of the first set of a rotor and a stator.

It has been surprisingly found that the combination of the use of such aeration device with the composition as above defined leads to produce a chocolate mousse composition which retains its firmness over shelf-life and has a rapid melting in the mouth without using any texturizing ingredients, let alone without using egg yolk.

In one embodiment, the rotor and the stator of each set of a rotor and a stator may comprise one to five toothed rims. Preferably, the rotor and the stator of each set of a rotor and a stator comprises one to four, preferably two to four substantially parallel toothed rims. Advantageously, the rotor and the stator of each set of a rotor and a stator comprises three substantially parallel toothed rims.

In one embodiment, the toothed rim comprising teeth separated one from another by a radial gap. Preferably, the radial gap between the teeth of each toothed rims is of 0.5 mm to 5 mm, preferably 1 mm to 3.5 mm. The radial gap participates to achieve stable chocolate mousse composition by allowing the formation of gas bubbles with a minimal size and having size in the same range (homogenous bubble size).

In one embodiment, the aeration device comprises two to eight, preferably two to four sets of a rotor and a stator, including the first set of a rotor and a stator and the second set of a rotor and a stator. Preferably, the aeration device comprises four sets of a rotor and a stator, including the first set of a rotor and a stator and the second set of a rotor and a stator.

In a preferred embodiment, the aeration device comprises a first shaft coupled to the rotor of at least a first set of a rotor and a stator, and a second shaft coupled to the rotor of at least a second set of a rotor and a stator. The first shaft may be coupled to the rotor of a first set of a rotor and a stator and to the rotor(s) of one, two or three additional sets of a rotor and a stator. The second shaft may be coupled to the rotor of at least a second set of a rotor and a stator and to the rotor(s) of one, two or three additional sets of a rotor and a stator. In a preferred embodiment, the first shaft is coupled to the rotor of a first set of a rotor and a stator and to the rotors of two or three additional sets of a rotor and a stator, and the second shaft is coupled to the rotor of a first set of a rotor and a stator and to the rotors of two or three additional sets of a rotor and a stator. In a more preferred embodiment, the first shaft is coupled to the rotor of a first set of a rotor and a stator and to the rotors of three additional sets of a rotor and a stator, and the second shaft is coupled to the rotor of a first set of a rotor and a stator and to the rotors of three additional sets of a rotor and a stator.

In a further embodiment, the first shaft and the second shaft may be coaxial with a longitudinal axis (A) of the aeration device. In addition, the aeration device may be configured to drive the first shaft and the second shaft at different rotational speeds and/or in opposite directions. Especially, the aeration device may comprise independent driving means rotationally driving the first shaft and the second shaft respectively.

In one embodiment, the gas injector injects a gas under a pressure comprised between 0.5 bars and 10 bars, preferably between 3 bars and 7 bars.

In another embodiment, the pressure of the gas injected respectively in the first and the second aeration devices has the same value or a different value.

In one embodiment, the gas is a food grade gas, i.e. a gas suitable for human consumption. Preferably, the gas is selected from the list consisting of air, nitrogen, carbon dioxide, nitrous oxide, and combinations thereof. Advantageously, the gas is nitrogen.

In one embodiment, the drive shaft of the aeration device has a rotation speed comprised between 50 rpm and 1500 rpm, preferably comprised between 100 rpm and 600 rpm. Preferably, the drive shaft of the first and the second aeration devices has the same rotational speed or a different rotational speed.

According to a first embodiment, where there is a single drive shaft, the aeration step b) and c) are performed with the aeration device such that the drive shaft rotates at a rotation speed of 100 to 800 rpm, preferably of 100 to 700 rpm, more preferably of 100 to 600 rpm.

According to a second embodiment, where there are two drive shafts, i.e. first shaft and second shaft, the aeration steps b) and c) may be performed with the aeration device such that the first shaft and second shaft rotate at the same rotation speed or at a different rotation speed. Alternatively, the first shaft and second shaft rotate at a different rotation speed.

In one preferred embodiment, the aeration steps b) and c) may be performed with the aeration device wherein the first shaft and the second shaft rotate respectively at a rotation speed of 100 to 800 rpm, preferably of 100 to 700 rpm, more preferably of 100 to 600 rpm.

In one embodiment, the process further comprises an additional step of heat treating the chocolate ganache composition obtained at step a), said additional step being carried out before step b) or between step a) and step b).

Preferably, the additional step of heat treating the chocolate ganache obtained at step a) is carried out at a temperature from 50° C. to 130° C. and during a time comprised between 1 minute and 20 minutes. Advantageously, the temperature is increased gradually from 50° C. to 130° C. during a time comprised between 1 minute and 20 minutes.

This heat treatment step prevents any development of unwanted micro-organisms in the aerated dairy product over the shelf-life under storage conditions (e.g. chilled), such as bacteria or moulds that may affect negatively the organoleptic properties of the aerated dairy product, or that may be pathogenic.

In one embodiment, the heat-treated chocolate ganache composition has a viscosity of at most 2000 cP, preferably comprised between 1000 and 2000 cP.

The viscosity of the heat-treated chocolate ganache composition according to the invention is measured by a HAAKE™ VT-550 Viscometer equipped with a T/SV-DIN rotor.

After the mixing step d), the obtained chocolate mousse composition is cooled and stored under chilled conditions.

A third aspect of the invention also relates to a chocolate mousse composition according to the first aspect that may be obtained by the process according to the second aspect.

The technical features of the chocolate mousse composition and the process are above described and can be applied to the chocolate mousse composition according to the third aspect of the invention.

It has been surprisingly found that the specific composition according to the invention as above detailed combined with the process using a specific aeration device with specific parameters allows formulating a chocolate mousse composition which is free from texturizing ingredient and even free from egg yolk but which has the same firmness over shelf-life than home-made type composition comprising egg yolk and also has a melting profile similar to traditional home-made chocolate mousse.

Those skilled in the art will understand that they can freely combine all features of the present invention disclosed herein. In particular, features described for the product of the present invention may be combined with the process of the present invention and vice versa. Further, features described for different embodiments of the present invention may be combined.

### EXAMPLES

### Methods

The following methods were used in the present invention:

### a) Method to Measure the Firmness

The firmness of the chocolate mousse composition is measured directly in the pot by a texture analyzer, the composition has been placed beforehand in an incubation enclosure at a temperature of 8° C. The instrument is a TA-XT plus C. The measurement is a penetration using a home-made spoon probe, to a depth of 20 mm after triggering.

The main parameters are:
Mode: force in compression
Pre-test speed: 15 mm/s
Test speed: 15 mm/s
Post test speed: 15 mm/s
Distance: 20 mm
Trigger typa: auto: 1.5 g
Data acquisition rate: 200 pps

The calculated parameter is the maximum force (g) equivalent to the force at the maximum penetration depth.

### b) Method to Measure the Storage Modulus G′ and the Loss Modulus G″ Across Shear Stress

A Rheometer MCR302 was used to measure storage modulus, using a system PP sand blasted. Measurements were carried out at 8° C.

A gap of 1 000 micrometers was fixed between the measuring plates using a PTD200 steel flat plate geometry. The measurement was carried out at an angular frequency of 10 rad/s (=1.59 Hz), from 0.01 to 500%. The stress increments were done in log mode. The G′ and G″ values of the linear plateau region are taken from a standard Linear Visco-Elastic Plateau determination curve.

This measure translates the action of the tong in the mouth of the consumer and therefore allows determining the melting profile of the chocolate mousse composition across mechanical constraints.

### b) Method to Measure the Storage Modulus G′ and the Loss Modulus G″ Across Temperature

A Rheometer MCR302 was used to measure storage modulus, using a system PP sand blasted. Measurements were carried out at angular frequency of 20 rad/s and at 0.2% of deformation.

A gap of 1 000 micrometers was fixed between the measuring plates using a PTD200 steel flat plate geometry. The measurement was carried out from 8 to 50° C.

This measure translates the action of the temperature inside the mouth and therefore allows determining the melting profile of the chocolate mousse composition across thermal constraints.

### Example 1: General Method to Prepare a Chocolate Mousse Composition According to the Invention

The chocolate ganache was prepared by mixing in a tank, the chocolate ingredient, previously melted, with the dairy ingredients and optionally the added sugar at a temperature comprised between 3° and 60° C. for 1 to 10 minutes.

The chocolate ganache obtained previously was then heat treated in a plate heat exchanger equipment at a temperature gradually increased from 50° C. to 130° C. over a time comprised between 30 seconds and 5 minutes. After the heating treatment, the chocolate ganache was cooled down to a temperature comprised between 20 and 40° C. Then, the heat treated chocolate ganache was aerated with a first aeration device which is an apparatus as described in the present specification, and especially, of the same type as the ones described in WO2013/068426 A1, WO2017/067965 A1 or WO2018/197493 A1. Especially, in the present process, the aeration device comprises two shafts and comprises in total eight sets of a rotor and a stator. The first shaft is coupled to the rotors of four first sets of a rotor and a stator. The second shaft is coupled to the rotors of four second sets of a rotor and a stator. Each rotor and stator of each set of a rotor and a stator comprise 3 toothed rims with a radial gap of 3 mm.

The aeration parameters for aerating the sterilized chocolate ganache are provided in table 1.

TABLE 1
Aeration parameters for aerating the sterilized
chocolate ganache

| | Rotation speed of | Rotation speed of |
|---|---|---|
| | the first shaft | the second shaft |
| | (rpm) | (rpm) |
| Heat treated | 200-250 | 400-600 |
| chocolate ganache | | |

In parallel, the egg ingredient is aerated with the first aeration device or a second aeration device, wherein the second aeration device is implemented in series with the first aeration device and said second aeration device is an apparatus as described in the present specification, especially, of the same type as the ones described in WO2013/068426 A1, WO2017/067965 A1 or WO2018/197493 A1. Especially, in the present process, the aeration device comprises two shafts and comprises in total eight sets of a rotor and a stator. The first shaft is coupled to the rotors of four first sets of a rotor and a stator. The second shaft is coupled to the rotors of four second sets of a rotor and a stator.

The aeration parameters for aerating the egg ingredient are provided in table 2.

TABLE 2
Aeration parameters for aerating the egg ingredient

| | Rotation speed (rpm) |
|---|---|
| Egg ingredient | 400-600 |

Then the previously obtained aerated chocolate ganache and aerated egg ingredient were mixed and aerated together in the second aeration device to obtain the chocolate mousse composition according to the invention.

TABLE 3
Aeration parameters for obtaining the chocolate mousse composition

| | Rotation speed (rpm) |
|---|---|
| Chocolate | 400-600 |
| mousse | |
| composition | |

### Example 2: Chocolate Mousse Compositions C1 to C5 According to the Invention and Comparative Home-Made Type Chocolate Mousse CBM

5 chocolate mousse compositions C1 to C5 according to the invention were prepared following the general method above described with the ingredients listed in Table 4 with the corresponding proportion. The composition of the commercial home-made type chocolate mousse “Bonne Maman® mousse au chocolat” is found on the rear of the packaging. Some information for the chocolate mousse “Bonne Maman® mousse au chocolat” such as the contents of cream, of egg yolk, of egg white, of added sugars and other ingredients, that are present in the composition, cannot be found in the description of the commercially available composition and therefore are written as na in Table 4. The percentages correspond to weight percent with regards to the total weight of the composition.

TABLE 4
Compositions the chocolate mousse composition C1 to C5 according to the
invention and the comparative chocolate mousse composition CBM

| Composition | C1 | C2 | C3 | C4 | C5 | CBM |
|---|---|---|---|---|---|---|
| Mixture Cream and | 45.7 | 42.7 | 44.9 | 42.7 | 41.2 | — |
| butter (%) | | | | | | |
| Mixture of | 27.0 | 30.8 | 30.0 | 30.8 | 26.6 | — |
| Chocolate and | | | | | | |
| Cocoa (%) | | | | | | |
| Sugar (%) | 2.2 | 1.5 | — | 1.5 | 2.1 | na |
| Egg white (%) | 25.0 | 25.0 | 25.0 | 25.0 | 30.0 | na |
| Salt (%) | 0.1 | — | 0.1 | — | 0.1 | 0.15 |
| Whole egg (egg | — | — | — | — | — | 27.0 |
| yolk and egg white) | | | | | | |
| Chocolate | — | — | — | — | — | 33.0 |
| Cream | — | — | — | — | — | na |
| Total protein | 6.8 | 6.1 | 6.5 | 6.3 | 6.8 | 7.5 |
| content (%) | | | | | | |
| Total sugar content | 12.8 | 14.0 | 11.9 | 14.6 | 13.6 | 19.0 |
| (%) | | | | | | |
| Total fat content | 25.9 | 27.2 | 26.0 | 26.9 | 22.7 | 26.0 |
| (%) | | | | | | |
| Overrun | 75 | 80 | 93 | 90 | 65 | 55 |

### Example 3: Firmness of the Chocolate Mousse Composition C1 According to the Invention and the Comparative Home-Made Type Chocolate Mousse CBM

The firmness of the chocolate mousse composition C1 and CBM were measured according to the method above described after 14 days (D+14) and after 28 days (D+28) of storage under chilled conditions.

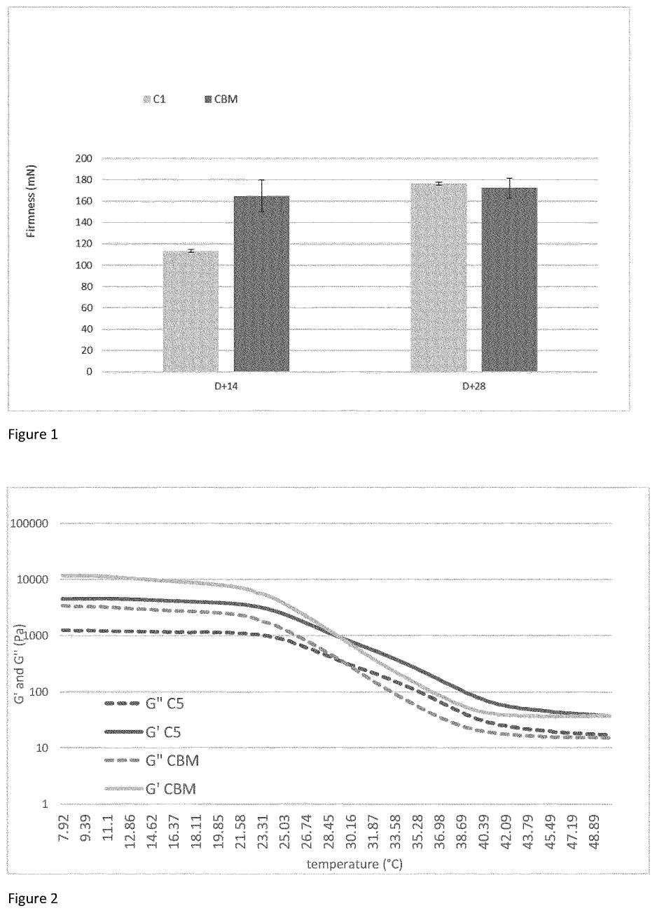

The results are shown in FIG. 1.

The firmness of the chocolate mousse composition C1 after 14 days of storage under chilled conditions is 113 mN and after 28 days of storage under the same chilled conditions is 176 mN.

The firmness of the comparative chocolate mousse CBM after 14 days and after 28 days of storage under the same chilled conditions than for C1 is respectively of 164 mN and of 172 mN.

These results show that the chocolate mousse composition according to the invention which is free from texturizing ingredient and also free from egg yolk has a firmness over shelf-life similar to the comparative chocolate mousse composition comprising egg yolk which promotes the firmness over shelf-life.

These results also demonstrate that the composition of the chocolate mousse composition obtained by the process according to the invention has a firmness over shelf-life similar to commercially available home-made type chocolate mousse comprising egg yolk.

### Example 4: Melting Profile of the Chocolate Mousse Composition According to the Invention and a Commercial Home-Made Type Chocolate Mousse CBM

The melting profiles of the chocolate mousse composition are determined by two measures:
Measure of the storage modulus (G′) and the loss modulus (G″) of said compositions across temperature translating the behaviour of said compositions with the temperature inside the mouth and/or,
Measure of the storage modulus (G′) and the loss modulus (G″) of said compositions across shear stress translating the behaviour of said compositions with the action of the tong in the mouth.

The combination of said two measures allows translating the overall melting profile of the chocolate mousse composition in the mouth of the consumer by having simultaneously the variation of temperature and the action of the tongue.

As shown in FIG. 2, the slopes of the curves G′ and G″ of C5 are less steep than the slopes of the curves G′ and G″ of CBM, meaning that the chocolate mousse composition according to the invention is melting more rapidly than the comparative chocolate mousse.

This result demonstrates that even with a similar firmness over shelf-life between the composition according to the invention and the comparative composition, the chocolate mousse composition according to the invention has a rapid melting profile and such profile is closer to home-made chocolate mousse than the comparative chocolate mousse.

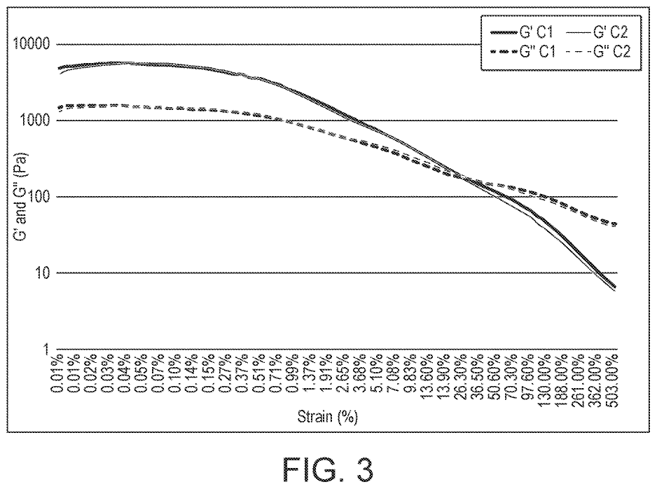

As shown in FIG. 3, the compositions according to the invention have an intersecting point in the same area of strain, meaning that all the compositions according to the invention have the same melting profile across shear stress.

These results mean that all the compositions of the invention are transitioning from the aerated phase to the liquid phase at the same time when a low pressure is applied.

These results shown in FIG. 3 also demonstrates that the compositions according to the invention have a rapid melting in the mouth because the pressure applied to make the transition from the aerated phase to the liquid phase is very low.

The combination of the curves shown in FIGS. 2 and 3 shows that the composition according to the invention which are free from texturizing ingredient and free from egg yolk, have a rapid melting in the mouth than the comparative composition comprising egg yolk and therefore have a melting profile which is closer to the melting profile of traditional home-made chocolate mousse.

1. A chocolate mousse composition comprising:
from 20 to 60% of at least one dairy ingredient,
from 10 to 40% of at least one chocolate ingredient,
from 10 to 40% of at least one egg ingredient,
wherein the composition is free from texturizing agent,
the percentages defined by weight of ingredient as compared to total weight of the composition.

2. The composition according to claim 1 comprising:
from 30 to 50% of the at least one dairy ingredient,
from 20 to 40% of the at least one chocolate ingredient,
from 10 to 30% of the at least one egg ingredient,
the percentages defined by weight of ingredient as compared to the total weight of the composition.

3. The composition according to claim 1 wherein the at least one dairy ingredient is selected from the group consisting of liquid milk, milk fat, milk powder, milk proteins, dairy curd, cream, buttermilk, condensed milk, butter and combinations thereof.

4. The composition according to claim 1, wherein the at least one chocolate ingredient is selected from the group consisting of chocolate, cocoa and combinations thereof.

5. The composition according to claim 1, wherein the at least one egg ingredient is egg white.

6. The composition according to claim 1, wherein the composition has a total fat content of at most 30% by weight as compared to the total weight of the composition.

7. The composition according to claim 1, wherein the composition comprises added sugars.

8. The composition according to claim 1, wherein the composition has an overrun of at most 100%.

9. A process for preparation of a chocolate mousse composition, the process comprising the steps of:
a) preparing a chocolate ganache composition comprising at least one dairy ingredient and at least one chocolate ingredient,
b) aerating the chocolate ganache composition obtained at step a) in a first aeration device to obtain an aerated chocolate ganache composition,
c) aerating at least one egg ingredient in the first aeration device used in step b) or a second aeration device different from the first aeration device used in step b), to obtain at least one aerated egg ingredient, and
d) mixing the aerated chocolate ganache composition obtained at step b) with the at least one aerated egg ingredient obtained at step c) in the second aeration device.

10. The process according to claim 9, wherein the step c) is carried out at the same time than the step b) or before the step b) or after the step b).

11. The process according to claim 9, wherein each of the first and second aeration devices comprises:
(i) a housing extending in a longitudinal direction, the housing comprising an inlet and an outlet;
(ii) within the housing, at least a first set of a first rotor and a first stator and a second set of a second rotor and a second stator, wherein each of the first and second sets has complementary toothed rims oppositely orientated in the longitudinal direction;
(iii) a drive shaft, the rotors of each of the first and second sets coupled to the drive shaft; and
(iv) a gas injector for injecting a gas, upstream of the first set of the first rotor and the first stator.

12. The process according to claim 9, wherein the first and the second aeration devices are in series.

13. The process according to claim 11, wherein the gas injector injects a gas under a pressure between 0.5 bars and 10 bars.

14. The process according to claim 9, wherein a pressure of a gas injected respectively in the first and second aeration devices has the same value or a different value.

15. The process according to claim 11, wherein the drive shaft of at least one of the first and second aeration devices has a rotation speed between 50 rpm and 1500 rpm.

16. The process according to claim 11, wherein the drive shaft of the first and the second aeration devices has the same rotational speed or a different rotational speed.

17. The process according to claim 9, comprising an additional step of heat treating the chocolate ganache composition obtained at step a), the additional step carried out before step b) or between step a) and step b).

18. The process according to claim 9, wherein the chocolate mousse composition comprises:
from 20 to 60% of the at least one dairy ingredient,
from 10 to 40% of the at least one chocolate ingredient,
from 10 to 40% of the at least one egg ingredient,
wherein the chocolate mousse composition is free from texturizing agent,
the percentages defined by weight of ingredient as compared to total weight of the chocolate mousse composition.

19. The composition according to claim 1, wherein the at least one dairy ingredient is selected from the group consisting of liquid milk, milk fat, cream, butter and combinations thereof; and the at least one egg ingredient is aerated egg white.

20. The composition according to claim 1, wherein the composition has a total fat content of 20% to 30% and an overrun between 50% and 100%.
